(19) United States
(12) Patent Application Publication
(10) Pub. No.: US 2013/0148814 A1
(43) Pub. Date: Jun. 13, 2013

(54) AUDIO ACQUISITION SYSTEMS AND METHODS

(71) Applicants: Muralidhar KARTHIK, Singapore (SG); Samuel Samsudin NG, Singapore (SG); Sapna GEORGE, Singapore (SG)

(72) Inventors: Muralidhar KARTHIK, Singapore (SG); Samuel Samsudin NG, Singapore (SG); Sapna GEORGE, Singapore (SG)

(73) Assignee: STMICROELECTRONICS ASIA PACIFIC PTE LTD, Singapore (SG)

(21) Appl. No.: 13/316,456

(22) Filed: Dec. 10, 2011

(51) Int. Cl. H04R 29/00

(52) U.S. Cl. 381/56

(57) ABSTRACT

Audio acquisition systems and methods to determine a direction of arrival of an audio signal are disclosed. In an embodiment, an apparatus includes a continuous sampling stage configured to receive audio information and to generate one or more correlations from the received audio information, and a processing stage configured to receive the one or more correlations and to generate direction of arrival information for the audio information. In another embodiment, a method includes generating audio signals from an ambient acoustic environment, and performing beamforming on the generated audio signals. The method further includes calculating signal-to-interference ratios from the beamformed signals, forming correlations between the signal-to-interference ratios and audio sampling angles, selecting at least one correlation based upon predetermined selection criteria, and determining a direction of arrival for the audio signals.

### TECHNICAL FIELD

This disclosure relates generally to audio systems and methods, and more particularly to audio acquisition systems and methods.

### BACKGROUND

In various audio acquisition systems, such as voice recording systems, voice recognition systems, audio and video recording systems, and video-conferencing systems, one or more microphones having fixed directivity may be used to acquire audio information. In general, more than one audio source may be present, which may be located at different distances and angles relative to the one or more microphones. Accordingly, it may be desirable to control the directivity of the microphones to improve the quality of an audio recording.

### SUMMARY

Audio acquisition systems and methods to determine a direction of arrival of an audio signal are disclosed. In an aspect, an apparatus includes a continuous sampling stage configured to receive audio information and to generate one or more correlations from the received audio information, and a processing stage configured to receive the one or more correlations and to generate direction of arrival information for the audio information. In another aspect, a method includes generating audio signals from an ambient acoustic environment, and performing beamforming on the generated audio signals. The method further includes calculating signal-to-interference ratios from the beamformed signals, forming correlations between the signal-to-interference ratios and audio sampling angles, selecting at least one correlation based upon predetermined selection criteria, and determining a direction of arrival for the audio signals.

### BRIEF DESCRIPTION OF THE DRAWINGS

Various embodiments are described in detail in the discussion below and with reference to the following drawings.

FIG. 1 is a block diagrammatic view of an audio acquisition system, according to the various embodiments.

FIG. 2 is an example of a continuous time-domain record of a signal-to-interference ratio (SIR), according to the various embodiments.

FIG. 3 is an example of a signal-to-interference ratio (SIR) angular variation, according to the various embodiments.

FIG. 4 is an example of a processed signal-to-interference ratio (SIR) angular variation, according to the various embodiments.

FIG. 5 is a flowchart describing a method of determining a direction of arrival of an audio receiving device, according to the various embodiments.

### DETAILED DESCRIPTION

Audio acquisition systems and methods that may be configured to determine a direction of arrival of an audio signal are disclosed. Briefly, and in general terms, the various embodiments may be configured to control the directivity of one or more microphones associated with the audio acquisition system by determining a direction of arrival of a selected audio signal. In the various embodiments, an audio acquisition system may also be configured to direct one or more video devices towards an audio source identified by the system.

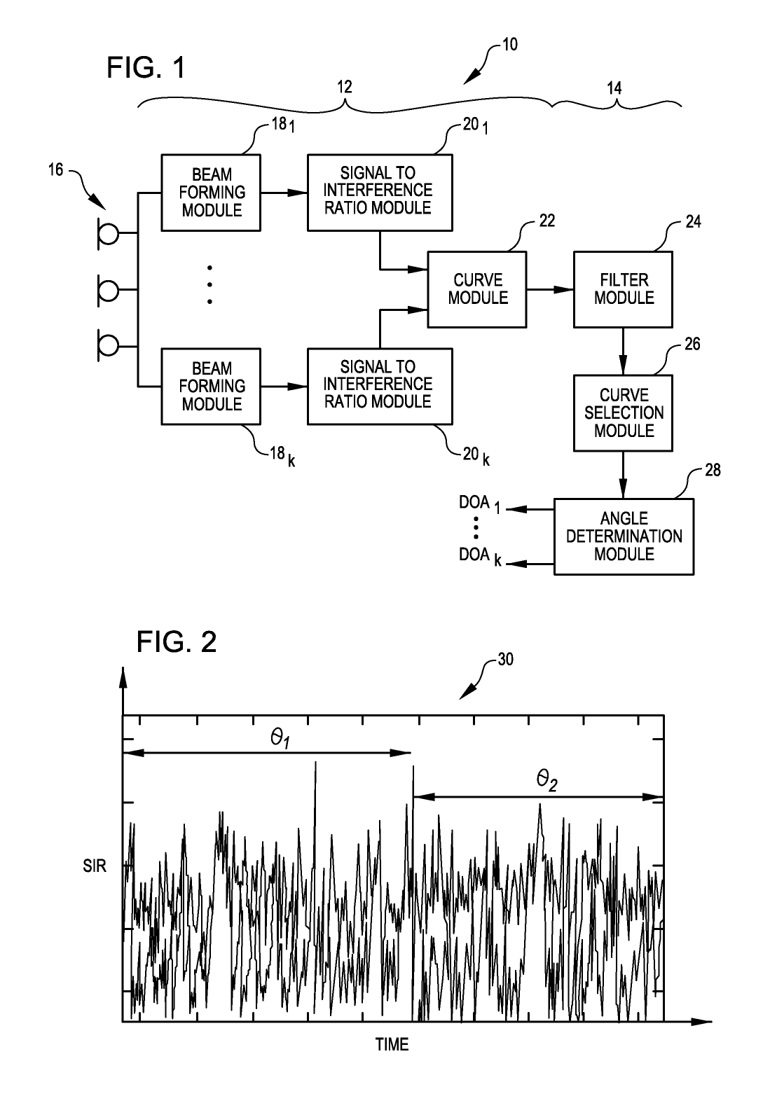

FIG. 1 is a block diagrammatic view of an audio acquisition system 10, according to the various embodiments. The system 10 may include a continuous sampling stage 12 that may be configured to continuously provide a sample output.

The continuous sampling stage 12 may be coupled to a processing stage 14, which may be configured to output a result after a predetermined number of samples from the continuous sampling stage 12 have been received. For example, the processing stage 14 may be configured to generate a result based upon at least one-thousand samples received from the continuous sampling stage 12. In accordance with the various embodiments, between approximately one-thousand and approximately two-thousand samples may be processed by the processing stage 14, although other sampling ranges or sampling limits may be selected. The continuous sampling stage 12 may include a microphone apparatus 16 that may be removably coupleable, which may include a single microphone, or alternatively, the microphone apparatus 16 may include a plurality of microphone devices that may be positioned at a variety of selected locations remote from the system 10. In accordance with the various embodiments, the microphone apparatus 16 may therefore include a uniform linear microphone array, a uniform circular array and a uniform square array orientation, among other suitable arrangements that may, in general, be configured to detect acoustical disturbances in an ambient acoustic environment. In the various embodiments, the maximum number of microphones in the microphone apparatus 16 may be limited only by processing capabilities of the system 10.

The continuous sampling stage 12 may also include one or more beamforming modules 18₁ through 18ₖ that may be operably coupled to the microphone apparatus 16. Briefly, and in general terms, the beamforming modules 18₁ through 18ₖ may be configured to alter an audio directionality of the microphone apparatus 16 by combining audio information received from the one or more microphones in the microphone apparatus 16. Accordingly, the beamforming modules 18₁ through 18ₖ may be configured to process received audio signals to produce a main signal lobe that may vary from approximately +90 degrees to approximately −90 degrees, where the angle may be measured relative to a line extending perpendicularly from the microphone apparatus 16. In addition to the main signal lobe, various signal nulls and signal side lobes may also be generated by the beamforming modules 18₁ through 18ₖ. A position of the signal nulls may be important, for example, in suppressing selected undesired audio signals that may be received by the microphone apparatus 16. The beamforming modules 18₁ through 18ₖ may be structured using an all-pass infinite impulse response (IIR) filter that may be configured with appropriate delays. For example, and in accordance with the various embodiments, a Thiran all-pass filter may be used. Suitable delay values may be selected as disclosed in “Fractional Delay Filter Based on the B-Spline Transform”, J. T. Olkkonen and H. Olkkonen, IEEE Signal Processing Letters, vol. 14, No. 2, February 2007, which reference is incorporated herein by reference in its entirety. The beamforming modules 18₁ through 18ₖ may also be configured to implement various algorithms, which may include a delay-and-sum beamforming algorithm, a linearly-constrained minimum variance beamforming algorithm, a time-domain generalized sidelobe canceller, and a robust generalized sidelobe canceller, as well as other suitable algorithms.

The continuous sampling stage 12 may also include signal-to-interference ratio (SIR) modules 20₁ through 20ₖ suitably coupled to the beamforming modules 18₁ through 18ₖ. The SIR modules 20₁ through 20ₖ may be configured to continuously receive information from the beamforming modules 18₁ through 18ₖ and to process the information to continuously generate a signal-to-interference ratio (SIR). The determination of the signal-to-interference ratio (SIR) will be discussed in greater detail below. The continuous sampling stage 12 may also include a curve module 22 that may be configured to receive information from the SIR modules 20₁ through 20ₖ and to process the received information to generate a selected correlation between the signal-to-interference (SIR) ratio and an audio sampling angle.

Still referring to FIG. 1, the processing stage 14 of the audio acquisition system 10 may include a filter module 24 that may be configured to receive the correlated information from the curve module 22 and to process the correlated information to select suitable correlations according to predetermined criteria. Briefly, and in general terms, the correlated information may include distributions of the signal-to-interference (SIR) ratio and the audio sampling angle. The filter module 24 may then be configured, for example, to process the distribution by determining multiple points of inflection in the distributions, and to select the distributions having a single point of inflection (e.g., a global minimum point) while discarding the distributions having multiple points of inflection. The filter module 24 will be discussed in greater detail below.

The processing stage 14 may also include a curve selection module 26 configured to receive the distributions processed by the filter module 24, and to further process selected correlations. For example, the curve selection module 26 may be configured to select a distribution having a suitable global minimum point. As a further example, the curve selection module 26 may be further configured to select a single distribution having one or more predetermined characteristics. In accordance with the various embodiments, the curve selection module 26 may select more than one distribution, however. The curve selection module 26 will also be discussed in greater detail below.

The audio acquisition system 10 may also include an angle determination module 28 that may be configured to receive the one or more distributions received from the curve selection module 26. The angle determination module 28 may accordingly generate direction-of-arrival (DOA) information DOA₁ through DOAₖ for audio signals detected by the microphone apparatus 16. For example, the DOA₁ through DOAₖ may include an angle of a source of audio signals relative to a position of each of the microphones included in the microphone apparatus 16. In accordance with the various embodiments, the DOA₁ through DOAₖ may be expressed in other forms that may express a direction of the audio signals received by the microphone apparatus 16.

The determination of the signal-to-interference ratio (SIR) will now be discussed in detail. A signal output from a selected microphone in the microphone apparatus 16 may be expressed as m(i,n), where i represents a selected microphone, and n represents a time or a sample value. Accordingly, an average value f(n) for the microphone response may be readily determined by summing the signal outputs for the various microphones in the microphone apparatus 16 (e.g., summing over the index):

f(n)=(1/(number of microphones))Σm(i,n)

For example, if the microphone apparatus 16 includes four microphones, then the average value f(n) becomes:

f(n)=0.25Σm(i,n)

Where the index i may be summed from one to four. Still assuming that the microphone apparatus 16 includes four microphones, a difference b(n) may be defined as:

b(n)=m(2,n)−m(3,n)

Accordingly, the following expressions for the microphone power may be formed:

P_{f}(n)=αP_{f}(n−1)+(1−a)f(n)f(n)

P_{b}(n)=αP_{b}(n−1)+(1−α)b(n)b(n)

The signal-to-interference ratio (SIR) may therefore be defined in terms of the foregoing expression:

SIRᵢ(n)=(P_{b}(n)/P_{f}(n))

Referring now to FIG. 2, an example of continuous time-domain record of a SIR 30 is shown. The SIR 30 may be generated, for example, by the signal-to-interference ratio (SIR) module 20₁ through 20ₖ shown in FIG. 1, or by other suitably configured modules. In FIG. 2, the SIR 30 is shown when any of the beamforming modules 18₁ to 18ₖ is directed to a first angle θ₁ and a second angle θ₂. It may be appreciated that the SIR 30 of a beamformer (e.g., any one of 18₁ to 18ₖ) that is assigned to direction θ₁ may have a relatively low value when an audio source positioned at the first angle θ₁ is operating and an audio source positioned at the second angle θ₂ is not operating. Conversely, the SIR 30 of a beamformer (e.g., any one of 18₁ to 18ₖ) that is assigned to direction θ₂ may have a relatively low value when an audio source positioned at the second angle θ₂ is operating and the audio source positioned at the first angle θₗ is not operating.

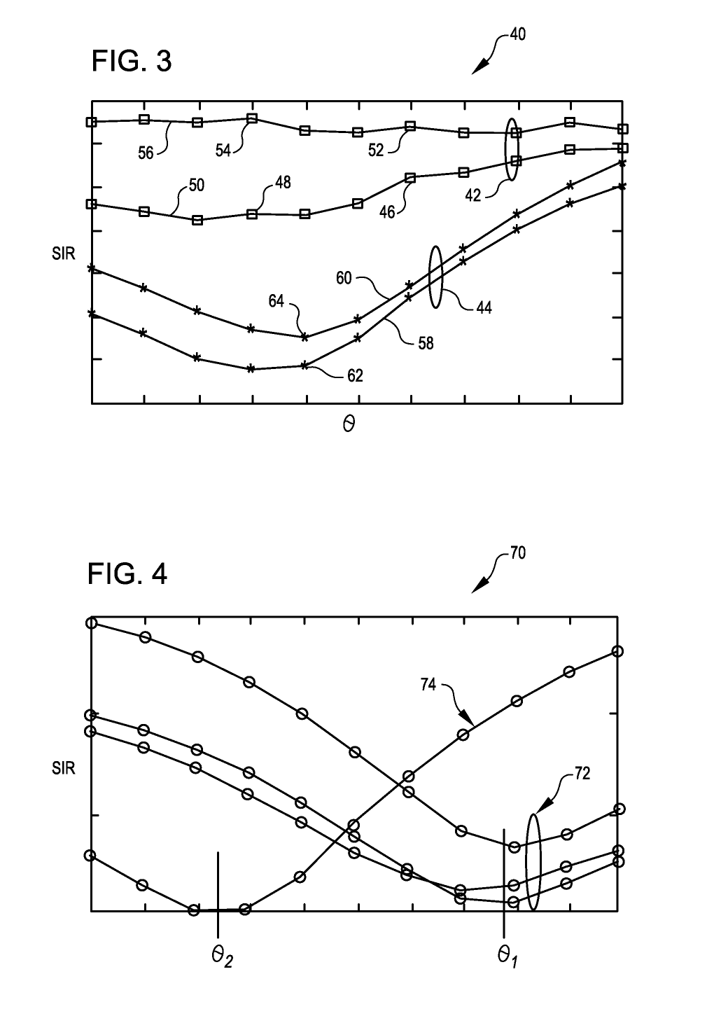

Referring now to FIG. 3, an example of a SIR angular variation 40 is shown. Briefly, the SIR angular variation 40 may be generated by processing the SIR 30 shown in FIG. 2 so that an angular dependency (e.g., an audio sampling angle) of the SIR 30 is expressed. The SIR angular variation 40 may be generated, for example, by the curve module 22 shown in FIG. 1, or by other suitably configured modules. The SIR angular variation 40 may include a first set of correlations 42 and a second set of correlations 44. The first set of correlations 42 includes one or more correlations having more than point of inflection. For example, the first set of correlations 42 includes the inflection points 46 and 48 on a first correlation 50, and the inflection points 52 and 54 on a second correlation 56. Although only the inflection points 52 and 54 on the first correlation 50, and the inflection points 46 and 48 on the second correlation 56 are identified, it is understood that there may be still other points of inflection in the first correlation 50 and the second correlation 56. The second set of correlations 44 may include, for example, a third correlation 58 and a fourth correlation 60 may be included in the second set of correlations 44, although more than two correlations may be present. The third correlation 58 may include a single point of inflection 62, while the fourth correlation 60 may also include a single point of inflection 64. The various points of inflection may be determined, for example, by locally computing slope values, and identifying a location of a sign change in the slope value, although other methods may also be used.

With continued reference to FIG. 3, points of inflection in the first set of correlations 42 and the second set of correlations 44 may be used to identify the suitable correlations. With reference again to FIG. 1, the filter module 24 may be suitably configured to perform this identification. For example, criteria for selection of the suitable correlations may include identifying more than one point of inflection in the various correlations, and rejecting the correlations having the more than one point of inflection. Accordingly, the first set of correlations 42 may not be retained, while the second set of correlations 44, may be retained. The selection criteria may also include identifying the correlations having a single point of inflection and retaining the correlations having the single point of inflection. Again, the first set of correlations 42 are not retained, while the second set of correlations 44, are retained. In either case, the correlations identified by the filter module 24 may be further processed by the curve selection module 26 of FIG. 1.

FIG. 4 is an example of a processed SIR angular variation 70. The processed SIR angular variation 70 may be generated, for example, by the curve selection module 26 of FIG. 1, or by other suitably configured modules. The processed SIR angular variation 70 may include a first group of correlations 72 that include minimum points proximate to a first angular position θ₁ of a first audio source, and a second group of correlations 74 that include minimum points proximate to a second angular position θ₂ of a second audio source that is physically spaced apart from the first audio source. The first group and the second group may include a single correlation, or they may include a plurality of correlations, as evidenced, for example, by the correlations shown in FIG. 4. In addition, it is understood that other groups of correlations may be present, which may be due to the presence of audio sources that are physically spaced apart from the first audio source and the second audio source.

The minimum points of the various groups may be determined by a variety of methods. For example, the minimum points may be located by progressively calculating a slope for lines tangent to the correlation, and finding a location on the correlation that corresponds to a selected numerical criterion ε so that the calculated slope may be less than, or equal to the numerical criterion ε, where ε may be a selected numerical value that is close to zero.

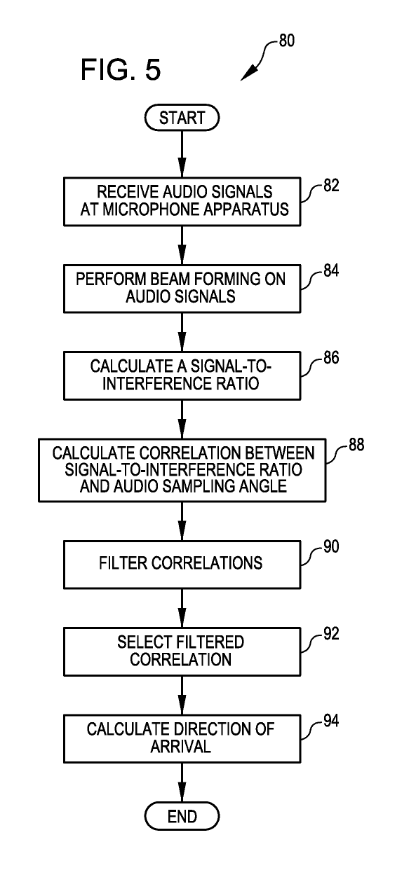

FIG. 5 is a flowchart that will be used to describe a method 80 of determining a direction of arrival of an audio receiving device, according to the various embodiments. At 82, the audio signals may be received at a microphone apparatus. The microphone apparatus 16 (FIG. 1) may include one or more microphone devices, which may include a linear array of microphones, or, more generally, it may include a plurality of microphones that are mutually physically spaced apart. At 84, the received audio signals may be subjected to a beamforming algorithm, as implemented, for example, by beamforming modules 18₁ through 18ₖ of FIG. 1. A signal-to-interference ratio may be calculated, as shown at 86. The signal-to-interference ratio may be calculated using the algorithm shown above, as implemented, for example, by the signal-to-interference modules 20₁ through 20ₖ of FIG. 1. The signal-to-interference ratio may be correlated with audio sampling angles at 88. The correlation may be implemented, for example, by the curve module 22, as again shown in FIG. 1. At 90, the correlations generated at 88 may be filtered. In particular, the correlations may be processed in order to select correlations having a selected number of inflection points, as discussed in greater detail above. At 92, the correlations selected at 90 may be further processed to select one or more correlations that may be used to identify a direction of arrival, as shown at 94.

From the foregoing it will be appreciated that, although various embodiments have been described for purposes of illustration, various modifications may be made without deviating from the spirit and scope of the disclosure. Moreover, although the functional description of the various embodiments may be associated with the various described modules, it is understood that the disclosed functionality may be associated with fewer modules, or even a greater number of modules without deviating from the scope of the various embodiments. The various disclosed modules may also be implemented exclusively in hardware or in software, or even in a combination of hardware and software. Where an alternative may be disclosed for a particular embodiment, this alternative may also apply to other of the various embodiments even if not specifically stated.

1. An apparatus, comprising:
a continuous sampling stage configured to receive audio information and to generate one or more correlations from the received audio information; and
a processing stage configured to receive the one or more correlations and to generate direction of arrival information for the audio information.

2. The apparatus of claim 1, wherein the continuous sampling stage comprises a microphone apparatus coupleable to the continuous sampling stage to receive the audio information.

3. The apparatus of claim 2, wherein the continuous sampling stage comprises a plurality of beamforming modules coupled to the microphone apparatus.

4. The apparatus of claim 3, wherein the plurality of beamforming modules comprise all-pass infinite impulse response filters configured with appropriate delay values.

5. The apparatus of claim 3, herein the plurality of beawmforming modules are configured to implement at least one of a delay and sum beamforming algorithm, a time-domain generalized sidelobe cancelling algorithm, and a robust generalized sidelobe cancelling algorithm.

6. The apparatus of claim 3, comprising signal-to-interference modules coupled to each of the plurality of beamforming modules that are configured to compute a signal-to-interference ratio.

7. The apparatus of claim 6, comprising a curve module coupled to the signal-to-interference modules configured to generate a correlation between the signal-to-interference ratio and an audio sampling angle.

8. The apparatus of claim 2, wherein the microphone apparatus includes one of a uniform linear microphone array, a uniform circular array and a uniform square array.

9. The apparatus of claim 1, wherein the processing stage comprises a filter module configured to determine points of inflection in signal-to-interference ratio correlations.

10. The apparatus of claim 9, wherein the filter module is configured to retain correlations having a single point of inflection, and discard correlations having more than one point of inflection.

11. An apparatus, comprising:
a continuous sampling stage having a microphone apparatus configured to generate audio signals from an ambient acoustic environment and to generate one or more correlations from the audio signals; and
a processing stage coupled to the continuous sampling stage and configured to receive the one or more correlations and to generate direction of arrival information for the microphone apparatus.

12. The apparatus of claim 11, wherein the continuous sampling stage comprises a plurality of beamforming modules coupled to the microphone apparatus.

13. The apparatus of claim 12, wherein the plurality of beamforming modules comprise all-pass infinite impulse response filters configured with appropriate delay values.

14. The apparatus of claim 12, comprising signal-to-interference modules coupled to each of the plurality of beamforming modules that are configured to compute a signal-to-interference ratio.

15. The apparatus of claim 14, comprising a curve module coupled to the signal-to-interference modules configured to generate a correlation between the signal-to-interference ratio and an audio sampling angle.

16. The apparatus of claim 11, wherein the microphone apparatus includes one of a uniform linear microphone array, a uniform circular array and a uniform square array.

17. The apparatus of claim 11, wherein the processing stage comprises a filter module configured to determine points of inflection in signal-to-interference ratio correlations.

18. The apparatus of claim 17, wherein the filter module is configured to retain correlations having a single point of inflection, and discard correlations having more than one point of inflection.

19. A method, comprising:
generating audio signals from an ambient acoustic environment;
performing beamforming on the generated audio signals;
calculating signal-to-interference ratios from the beamformed signals;
forming correlations between the signal-to-interference ratios and audio sampling angles;
selecting at least one correlation based upon predetermined selection criteria; and
determining a direction of arrival for the audio signals.

20. The method of claim 19, wherein selecting at least one correlation based upon predetermined selection criteria comprises filtering the correlation to select the one correlation.

21. The apparatus of claim 20, wherein filtering the correlation comprises retaining correlations having a single point of inflection.

22. The method of claim 20, wherein filtering the correlation comprises discarding correlations having more than one point of inflection.

23. The method of claim 19, wherein generating audio signals from an ambient acoustic environment comprises detecting the ambient acoustic environment using a microphone array.

24. The method of claim 19, wherein performing beamforming on the generated audio signals comprises beamforming using an all-pass infinite impulse response filter configured with an appropriate delay value.

25. The method of claim 19, wherein performing beamforming on the generated audio signals comprises implementing at least one of a delay and sum beamforming algorithm, a time-domain generalized sidelobe cancelling algorithm, and a robust generalized sidelobe cancelling algorithm.
